(19) United States
(12) Patent Application Publication
(10) Pub. No.: US 2006/0267952 A1
(43) Pub. Date: Nov. 30, 2006

(54) Interactive display table top

(76) Inventor: Steve Alcorn, Orlando, FL (US)

Correspondence Address: LITMAN LAW OFFICES, LTD, PO BOX 15035, CRYSTAL CITY STATION, ARLINGTON, VA, 22215, US

(21) Appl. No.: 11/137,610

(22) Filed: May 26, 2005

(51) Int. Cl. G09G 5/00

(52) U.S. Cl. 345/173

(57) ABSTRACT

An interactive display table system includes a horizontally disposed upward facing display device for displaying video signals, a transparent touch sensitive overlay input device mounted over the top of the display device, and a transparent protective covering device mounted over the top of the transparent touch sensitive overlay input device and the display device. A housing receives the sub-assembly comprising the display device, the transparent touch sensitive overlay input, the transparent protective covering device and a controller having an output video connection to the display device and an input connection to the transparent touch sensitive input device. The interactive display table system may also be connected to multiple interactive display table systems via a network to coordinate networked graphical presentations on each interactive display table.

### BACKGROUND OF THE INVENTION

1. Field of the Invention

The present invention relates to an interactive graphical display table system that reacts to user input in the form of touching or placing objects on the interactive graphical display table system by generating graphical images and animations responsive to the input. More particularly, the invention is directed to a large size graphical display device mounted in a horizontal configuration for use as a table having a transparent touch sensitive input device located over the viewing surface of the display device. Input from the touch sensitive input device causes a controller to generate graphical ambiences for the display device and to generate graphical input effects based on input from the touch sensitive input device.

2. Description of the Related Art

The requirement of generating increased sales of food and beverages in the restaurant and bar industry has long existed.

The object of this invention relates to the use of large-size graphical display monitors mounted in a horizontal fashion in food and beverage establishments that respond to objects placed on or removed from the graphical display monitors by generating graphical images and animations. This invention addresses the aforementioned requirements by causing patrons to become occupied with these graphical images and animations each time food or beverages are placed on the graphical display monitors, thereby causing increased sales of food and beverages.

Although a handful of other devices are known, no other device meets the objectives of providing a horizontally mounted large-size graphical display monitor that responds to user input on the surface of the large-size graphical display monitor by creating graphical and animation ambiences and effects.

### SUMMARY OF THE INVENTION

The interactive display table system of the present invention includes a horizontally disposed upward facing display device for displaying video signals, a transparent touch sensitive overlay input device mounted over the top of the display device, and a transparent protective covering device mounted over the top of the transparent touch sensitive overlay input device and the display device. A housing receives the sub-assembly comprising the display device, the transparent touch sensitive overlay input, the transparent protective covering device and a controller having an output video connection to the display device and an input connection to the transparent touch sensitive input device. Furthermore, the housing compartment encloses the controller and the connections to the display device and the transparent touch sensitive input device.

An interactive display surface system of the present invention has a graphical display device including a transparent touch sensitive overlay input device, a network device, and a controller connected to the video display, the touch sensitive overlay input device, and the network device. The controller further includes an operating system for interfacing with the graphical display device, the transparent touch sensitive overlay input device, and the network device, and an interactive display surface system software application.

The interactive display surface system software application further comprises a central control module for communicating system messages to and from the operating system and communicating to a series of input handlers and output managers. The first in a series of input handlers is a touch sensor input handler in communication with the central control module for analyzing coordinates sent from the transparent touch sensitive overlay input device, and for determining when to apply a graphical change or effect to the video display device. A schedule input handler in communication with the central control module communicates real time clock information to and from the central control module for starting playlists, schedules, individual effect files, logging of activities of the schedule handler, and issuing operational commands to the central control module. A playlist input handler in communication with the central control module launches individual effect files, schedule files, other playlists, logging activities of the playlist handler, and issuing operational commands to the central control module. And finally, a network message input handler in communication with the central control module monitors commands sent from a network to the central control module.

The first in series of output managers is an operating system output manager in communication with the central control module that reboots or shuts down the system, manages FTP server parameters, creates FTP users, and logs all of the operating system output manager activities. A display window output manager in communication with the central control module controls video output to the video display device. A physical display output manager in communication with the central control module controls hardware display settings on the video display device. And finally, a network manager in communication with the central control module controls network access via a wired or wireless network adapter device, creates and manages TCPIP values in the system, and transmits notifications to remote servers in a network.

The present invention also includes a method of controlling an interactive display surface system, the interactive display surface system having a video display device including a transparent touch sensitive overlay input device, and a controller connected to the video display device and the touch sensitive overlay input device. The method of controlling provides an ambience background display, and changes the ambience background display to an alternate ambience background display every few minutes. Input to the touch sensitive overlay input device is input, and the system responds to the input by creating an effect to be displayed on the video display device at a location relative to the input provided to the touch sensitive overlay input device. When the input from the touch sensitive overlay input device is removed, the system responds by creating a new effect or continuing the created effect on the video display device at the location relative to the input provided to the touch sensitive overlay input device.

An additional feature of the invention includes a method of controlling a network of interactive display surface devices, wherein each of the interactive display surface devices in the network has a video display device, a transparent touch sensitive overlay input device, and a controller connected to the video display device, and the touch sensitive overlay input device, and the controller is in communication with the network of interactive display surface devices. The system provides an ambience background display at a first interactive display surface device and communicates information of the ambience background display to the network of interactive display surface devices. A correlating ambience background display is provided at a second interactive display surface device once the information of the display is communicated.

These and other features of the present invention will become readily apparent upon further review of the following specification and drawings.

### BRIEF DESCRIPTION OF THE DRAWINGS

FIG. 1 is an environmental, perspective view of an interactive display table according to the present invention.

FIG. 2 is a cross-sectional assembly view of an interactive display table according to him to the present invention.

FIG. 3 is a diagram of an application software system that controls an interactive display table according to the present invention.

FIGS. 4A-D are logic flow chart diagrams that show a decision-making process used by various interface handlers according to an interactive display table of the present invention.

Similar reference characters denote corresponding features consistently throughout the attached drawings.

### DETAILED DESCRIPTION OF THE PREFERRED EMBODIMENTS

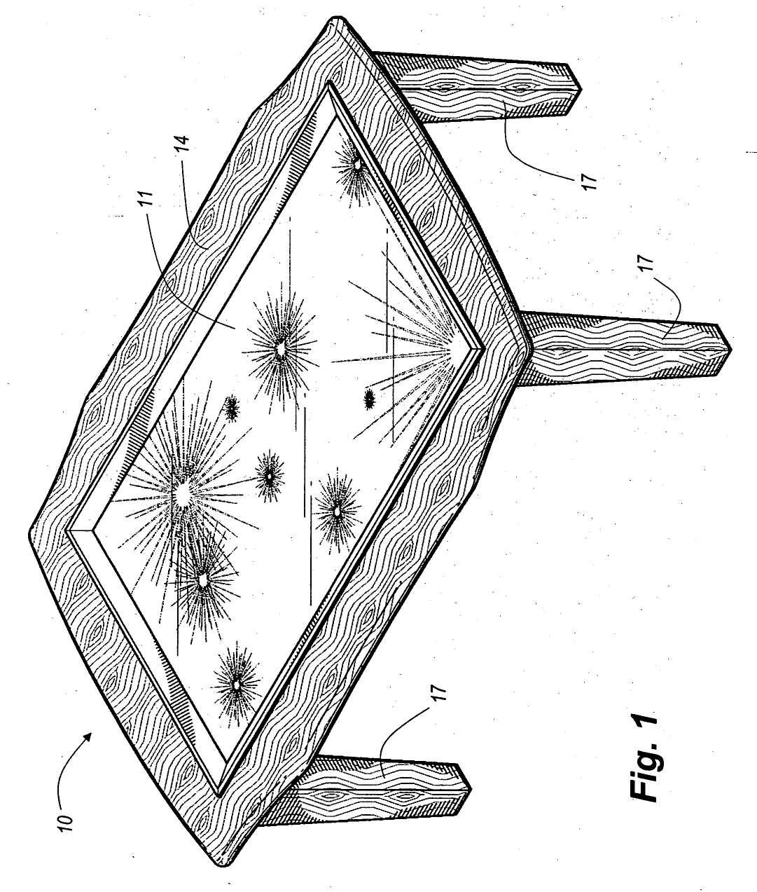

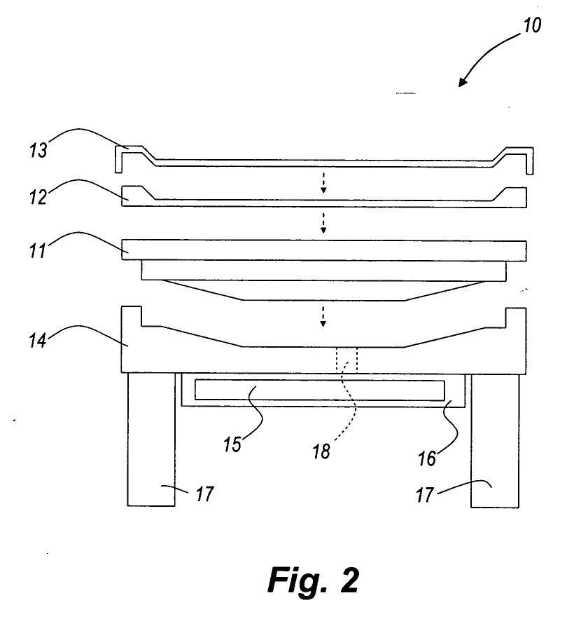

With respect to FIGS. 1 and 2, an interactive display table 10 has a video display 11 horizontally mounted within the top surface of the table 14 such that the video display device faces directly upward. A transparent touch sensitive overlay device 12 is mounted directly on top of the video display device 11 so that there is no visual obstruction of the output of the video display device 11. The transparent touch sensitive overlay device 12 identifies the local coordinates of any touch input via touch or tactile sensors that can be pressure sensitive input devices, infrared sensors, or like. The sensors can track large and small items placed on the surface, such as a customer's drink or car keys. A transparent protective covering 13 covers the touch sensitive overlay device 12 and the video display device 11 to protect from dirt, environmental contaminants, spilled food or beverages, constant wear from high use environments, and any potentially damaging objects to the video display device 12. The transparent protective covering 13 typically is a vacuum-formed acrylic covering which is mounted into place over the top of the display surface 11 with screws or other appropriate locking mechanisms.

FIG. 2 shows an assembly view of the interactive display table to hand wherein the transparent protective covering 13 covers over the touch sensitive overlay device 12 that rests upon the video display surface of video display 11. This assembly then is lowered into an upper cavity on the top surface of table 14 to provide a uniformly flat table surface. A controller 15 is connected to video display device 11 and touch sensitive overlay device 12 via thruway 18 and mounts under or below the upper surface of table 14. A protective housing 16 holds controller 15 and prevents unwanted access to controller 15 from unauthorized users or damage from those sitting at table 14. The housing 16 may be comprised of the rest of the table body 14, and may be made of wood, plastic, metal, glass or other suitable materials. Table legs 17 extend downward from the rear surface of table 14. Table 14 can be support with a plurality of legs at various heights, for example, a standard table height or a coffee table height, or may be supported in a countertop configuration, for example, on the top of a bar.

The controller 15 is an embedded device running an operating system and custom software for controlling the display 11 and is placed in the housing described above. The controller 15 continuously monitors for any touch sensitive display device data from the touch sensitive overlay device 12, and generates an output video signal that is compatible with the video display device's 11 required video input formats. The video display device 11 can be a plasma display screen, an LCD display screen, a CRT display screen, a rear-projection television display screen, an LED matrix or a video projection device. The output video signal of controller 15 can comprise raster graphics, vector graphics, text, HTML, graphic animations, video, and all commonly supported Web browser graphic media.

Controller 15 may also communicate with other video display devices 11 via a communication network. To accomplish this, controller 15 may have a wired or wireless network communication port such as an Ethernet port.

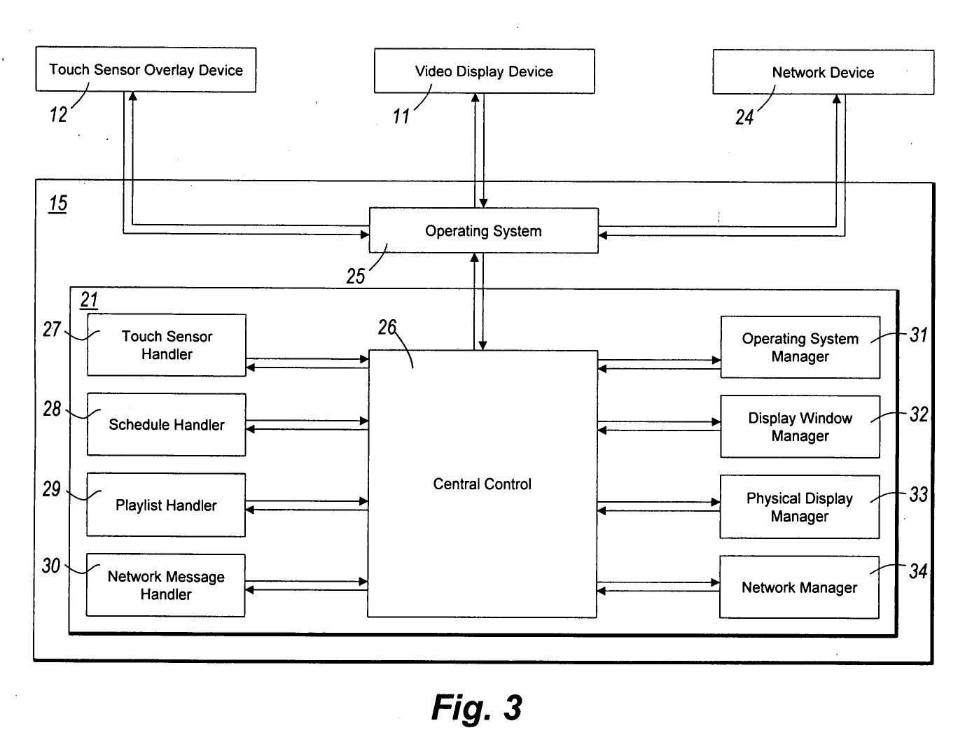

With respect to FIG. 3, controller 15 communicates with the touch sensitive overlay device 12, the display device 11, and a network device 24 through an operating system that manages hardware communications between the external devices (11, 12 and 24) and a software control application 21. A central control module 26, manages the communication between control interfaces handlers and output manager modules. The central control module 26 handles routing of incoming system messages to the various handlers, and implements commands sent from the various output managers to the output devices.

The first of the control interface handlers is a touch sensor input handler 27 which analyzes coordinates received from the touch sensitive overlay input device 12 and determines when to apply a graphical change or effect to the video display device 11. This portion of the code analyzes coordinates sent to the program from the touch sensor 12. This portion of the code indicates where the last item was placed on the table or if any items are remaining on the table. These items are objects substantial enough to cause the touch sensor to communicate a different coordinate. For example, items that can trigger this message are a finger, a drink glass, a purse, a bowl, etc. Responsive to these coordinates, the graphical changes or effects can be comprised of two different types of graphical information in the preferred invention: an ambience graphic, or an effect graphic. An ambience graphic changes the entire screen of the graphic display device 11, either in color, as a theme or an overall animation. The effect graphic is a localized graphic that takes place on the graphic display device 11 only at or around the point where there is input on the touch sensitive input device 12. On a new coordinate message, the touch sensor handler decides whether an ambience change or graphic effect needs to occur on the display in some predetermined fashion, such as highlighting a graphical object or performing the appropriate response for the current graphic effect.

The second of the control interface handlers is a schedule input handler 28 that communicates real-time clock information to and from the central control module 26 to start playlists of ambiences or effects, schedules for graphical output of ambience or effects, individual effect files, logging of activities of the schedule handler, and issuing operational commands to the central control module 26. The schedule input handler 28 uses time of day information from the central control module 26 to control these various functions.

The third of the control interface handlers is a playlist input handler 29 that launches individual effect files, schedules ambiences or effect files, other playlists, logging activities of the playlist handler, and issuing operational commands to the central control module. The playlist input handler 29 generally controls the sequence of various operations in the controller 15.

The fourth of the control interface handlers is a network message input handler 30 that monitors commands sent from the network to the central control module 26. Upon receipt of any network message, network message handler 30 routes commands through central control 26 to the appropriate output manager.

The first of the output managers is an operating system manager 31 that controls the rebooting or shutting down of the display system, managing of FTP server parameters, creation of FTP users, and logging all of the operating system output manager activities.

The second of the output managers is a display window output manager 32 that controls the video output to the display device 11 so that all graphic image, animations, and video file types are properly displayed on the output device 11.

The third of the output managers is a physical display output manager 33 that controls hardware display settings on the video display device 11. These hardware display settings may include screen resolution, screen sleep mode, and screensaver shut off settings.

The fourth of the output managers is a network manager that controls network access via either a wired or wireless network adapter device and creates and manages TCP/IP values in the system and transmits notifications to remote servers in a network.

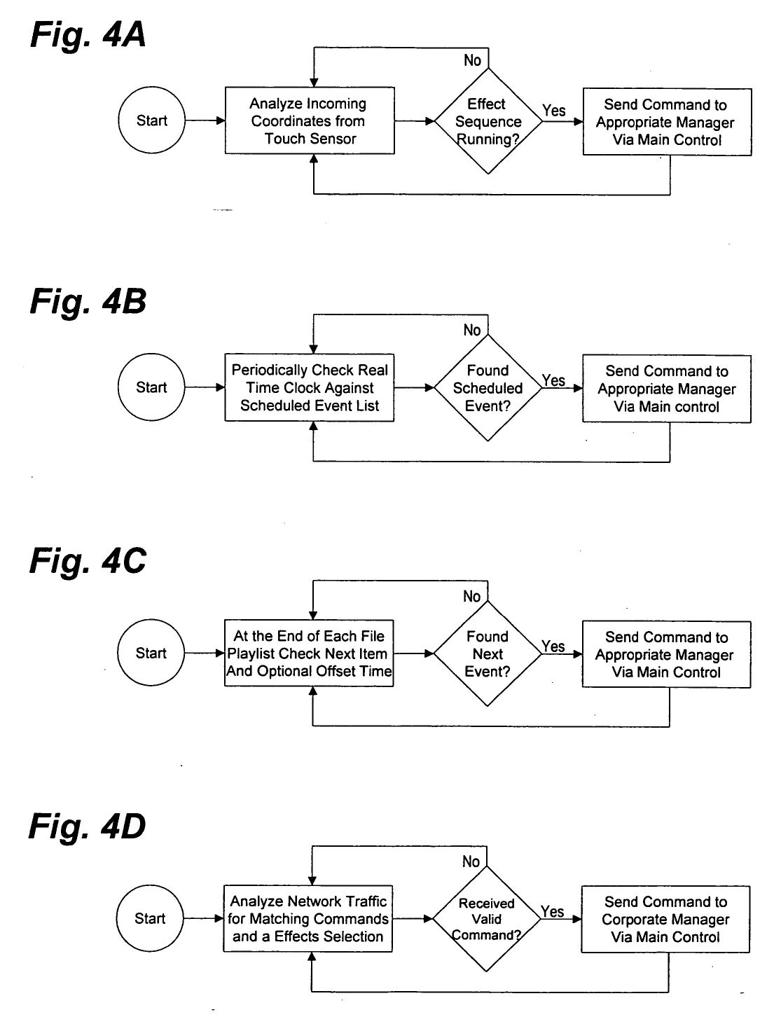

FIGS. 4A-D illustrate a series of decision-making processes used by various interface handlers. Notice “events” referred to in the diagrams may be any operation undertaken by the system like starting a new effect or ambience, rebooting of the system, to FTP a file, etc.

FIG. 4A illustrates the logic sequence of the touch sensor handler 27 determining if an effect sequence is running. If an effect sequence is determined to be running, the touch sensor handler 27 sends a command to the appropriate output manager via central control 26.

FIG. 4B illustrates the logic sequence of the schedule handler 28 determining if an event is scheduled. If an event is determined to be scheduled, the schedule handler 28 transmits a command to the appropriate output manager via central control 26.

FIG. 4C illustrates the logic sequence of the playlist handler 29 that determines if a next event is found. If an event is found, the playlist handler 29 transmits a command to the appropriate output manager via central control 26.

FIG. 4D illustrates the logic sequence of the network message handler 30 that determines if a valid command has been received. If a valid command has been received, the network message handler 30 transmits a command to the appropriate output manager via central control 26. All of these previous examples of FIGS. 4A-D illustrate the logic of the input handler's in determining certain system parameters and routing command messages through the central control 26 to corresponding output managers.

A first embodiment of the present invention provides for an ambience background display on the interactive display device. This ambience background display fills the entire display device screen, and alternates between a variety of ambience background displays every few minutes. By providing input to the touch sensitive overlay input device, the interactive display device table responds graphically by generating graphical images or animations on or around the location provided by the touch sensitive overlay input device. When that which caused the input to the touch sensitive overlay input device is removed, a new graphic effect is generated and displayed on or near the location where the initial touch input originated.

A second embodiment of the present invention provides for a network of interactive display tables, where each of the interactive display tables are connected to each other via a wired or wireless network. When a first interactive display table generates either an ambience or an effect, communication of that ambience or effect is transmitted to the remaining interactive display tables in the network. When the communication is received by the remaining interactive display tables in the network, a correlating ambience is generated on each of the remaining interactive display tables. These subsequent generated ambiences may be delayed by predetermined amounts of time, to create a chase effect of ambiences on the interactive display table network. Additionally, a graphic effect display at a single interactive display table may communicate information to adjacent interactive display tables in the network to generate corresponding graphic effects at those adjacent interactive display tables.

The practical effect of the present invention is to encourage consumption of drinks and food, thereby increasing bar or restaurant revenues. Each time a patron sees a new ambient or graphic effect, he will be encouraged to raise his glass, and will naturally be inclined to take a sip while experimenting with the behavior of this new effect. The graphic ambience and graphic effects may be sold on a subscription basis. The interactive display table connects to the Internet via a wired or wireless connection and downloads new ambient or graphic effects periodically. Examples of effects may include: a star field effect, that causes a black hole under an object placed on the touch sensitive input wherein surrounding stars are sucked into it; blowing smoke through a wind tunnel, where objects placed on the display surface form a graphical obstruction and cause graphic turbulence around the objects; lava, wherein graphical lava flows around an object set on the display surface; bubbles, form in a burst when an object on the display surface is set down; ocean waves, that break around an object set on the display surface as if it were a rock or other obstruction; coral reef, where fish and sea animals are attracted or frightened by objects placed on the display surface; an animated or static logo of the establishment that operates the interactive display surface which appears when objects are put on the display surface; a line drawing routine, where lines are drawn between items placed on the display surface and are redrawn whenever an item is removed or moved to a new location. These examples are only illustrative of the difference graphical animations that may be programmed into the system.

Additional information that may be displayed on the interactive display tables are signals to clients when seating in the restaurant becomes available, the display of an establishment's menu, the display of an establishment's logo, other informational displays such as sports scores, Keno numbers, weather, or video or lighting effects.

The interactive display table can also be configured to have an interactive request indicator on one predesignated portion of the display device screen wherein a patron can touch this portion to change a graphic indicator from one color to another, which indicates when another round of drinks or service is desired. The indicator can be easily glimpsed by passing waitpersons, making service more efficient particular in noisy environments.

The interactive display table of the present invention may be configured in a network setting of more than one interactive display table to perform special presentations of graphical or video images. For example, separate pieces of a single static or moving image may be divided and displayed in portions on separate interactive display tables in a single network. Additionally, a network configuration of interactive display tables may be configured to provide a variety of competitive interactive games at two or more interactive display tables to solicit competitive interaction between patrons seated at those interactive display tables.

It is to be understood that the present invention is not limited to the embodiments described above, but encompasses any and all embodiments within the scope of the following claims.

I claim:

1. An interactive display surface apparatus comprising:
a horizontally disposed upward facing display device for displaying video signals;
a transparent touch sensitive overlay input device mounted over the top of said display device;
a transparent protective covering device mounted over the top of said transparent touch sensitive overlay input device and said display device;
a housing device that receives a sub-assembly comprising said display device, said transparent touch sensitive overlay input, and said transparent protective covering device;
a controller having an output video connection to said display device and an input connection to said transparent touch sensitive input device; and
a housing compartment for enclosing said controller and said connections to said display device and said transparent touch sensitive input device.

2. The interactive display surface apparatus of claim 1, wherein said housing device is vertically supported from the ground by a vertical support.

3. The interactive display surface apparatus of claim 2, wherein said vertical support further comprises one of the group consisting of:
a plurality of support legs; and
a floor mounted countertop.

4. The interactive display surface apparatus of claim 1, wherein said controller has communication ports further comprising of one of the group consisting of:
a wired network communication port, or
a wireless network communication port.

5. The interactive display surface apparatus of claim 1, wherein said controller further comprises an operating system and video generation software.

6. The interactive display surface apparatus of claim 1, wherein said horizontally disposed upward facing display device comprises a video display device.

7. The interactive display surface apparatus of claim 6, wherein said video display device is further comprises one of the group consisting of:
a plasma display screen;
an LCD display screen;
a CRT display screen;
a rear-projection television display screen;
an LED matrix; and
a video projection device.

8. The interactive display surface apparatus of claim 7, wherein said transparent touch sensitive overlay input device further comprises location sensors that determine the location of any tactile input presented upon said touch sensitive overlay input device.

9. The interactive display surface apparatus of claim 1, wherein said transparent protective covering device is a vacuum-formed acrylic covering affixed to said transparent touch sensitive overlay input device and said horizontally disposed upward facing display device.

10. The interactive display surface apparatus of claim in 1, wherein said video signals further comprise:
raster graphics;
vector graphics;
text data;
HTML data;
graphic animations;
video; and
all commonly supported Web browser graphics.

11. The interactive display surface apparatus of claim in 1, further comprising:
a network connection device for allowing downloading of new graphical effects for display on said interactive display surface apparatus.

12. An interactive display surface system having a graphical display device including a transparent touch sensitive overlay input device, a network device, and a controller connected to said video display, said touch sensitive overlay input device, and said network device, wherein said controller further comprises:
A) an operating system for interfacing with said graphical display device, said transparent touch sensitive overlay input device, and said network device; and
B) an interactive display surface system software application, said interactive display surface system software application further comprises:
1) a central control module for communicating system messages to and from said operating system and communicating to a series of input handler and output manager modules;
2) a touch sensor input handler in communication with said central control module, for analyzing coordinates sent from said transparent touch sensitive overlay input device, and for determining when to apply a graphical change or effect to said video display device;
3) a schedule input handler in communication with said central control module that communicates real time clock information to and from said central control module for starting playlists, schedules, individual effect files, logging of activities of said schedule handler, and issuing operational commands to said central control module;
4) a playlist input handler in communication with said central control module for launching individual effect files, schedule files, other playlists, logging activities of said playlist handler, and issuing operational commands to said central control module, and
5) a network message input handler in communication with said central control module for monitoring commands sent from a network to said central control module;
6) an operating system output manager in communication with said central control module for rebooting or shutting down said system, managing FTP server parameters, creation of FTP users, and logging all of said operating system output manager activities;
7) a display window output manager in communication with said central control module for controlling video output to said video display device;
8) a physical display output manager in communication with said central control module for controlling hardware display settings on said video display device; and
9) a network manager in communication with said central control module for controlling network access via a wired or wireless network adapter device, creating and managing TCP/IP values in said system, and transmitting notifications to remote servers in a network.

13. A method of controlling an interactive display surface system, said interactive display surface system having a video display device including a transparent touch sensitive overlay input device, and a controller connected to said video display device and said touch sensitive overlay input device, said method of controlling comprising the steps of:
providing an ambience background display;
changing said ambience background display to an alternate ambience background display every few minutes;
providing input to said touch sensitive overlay input device;
responding to said input from said step of providing by creating an effect to be displayed on said video display device at a location relative to said input provided to said touch sensitive overlay input device;
removing said input from said step of providing input from said touch sensitive overlay input device; and
responding to said step of removing said input by creating a new effect or continuing said created effect on said video display device at said location relative to said input provided to said touch sensitive overlay input device.

14. A method of controlling a network of interactive display surface devices, wherein each of said interactive display surface devices in said network has a video display device, a transparent touch sensitive overlay input device, and a controller connected to said video display device, and said touch sensitive overlay input device, and said controller is in communication with said network of interactive display surface devices, said method of controlling comprising the steps of:
providing an ambience background display at a first interactive display surface device;
communicating information from said step of providing an ambience background display to said network of interactive display surface devices; and
providing a correlating ambience background display at a second interactive display surface device based on said step of communicating information.

15. The method of controlling a network of interactive display surface devices of claim 14, wherein said step of providing a correlating said ambience background display at said second interactive display surface device is delayed by a predetermined amount of time.

16. A method of controlling a network of interactive display surface devices of claim 14, further comprising the steps of:
providing an effect display at said first interactive display surface device;
communicating information from said step of providing an effect display to said network of interactive display surface devices; and
providing a correlating effect display at said second interactive display surface device based on said step of communicating information from said step of providing an effect display.

17. A method of controlling a network of interactive display surface devices of claim 14, further comprising the steps of:
providing separate graphical images of one graphical static or moving image on each of said interactive display surface devices in said network.

18. A method of controlling a network of interactive display surface devices of claim 14, further comprising the steps of:
creating forms of competitive interaction games between different interactive display surface devices in said network.
